(19) United States
(12) Patent Application Publication
(10) Pub. No.: US 2026/0200568 A1
(43) Pub. Date: Jul. 16, 2026

(54) PASS-THROUGH FITTING ASSEMBLY FOR OUTBOARD ENGINE ASSEMBLY

(71) Applicant: BRP US Inc., Sturtevant, WI (US)

(72) Inventors: Roger RAETZMAN, Pleasant Prairie, WI (US); Justin JOHNSON, Silver Lake, WI (US); Dillon SAVAGE, Waterford, WI (US)

(21) Appl. No.: 19/405,577

(22) Filed: Dec. 2, 2025

Related U.S. Application Data
(60) Provisional application No. 63/745,886, filed on Jan. 16, 2025.

(51) Int. Cl. B63H 20/32; B63H 20/00; B63H 20/24

(52) U.S. Cl. CPC B63H 20/32; B63H 20/001; B63H 20/24

(57) ABSTRACT

An outboard engine assembly has a pass-through fitting and a seal. The pass-through fitting has: a body having a first end and a second end, the body defining a body passage extending axially from the first end to the second end; and a flange extending radially outwardly from the body, the flange being disposed axially between the first end and the second end, the body having a threaded portion disposed axially between the first end and the flange. The seal abuts the body for sealing in a radial direction between the body and a threaded component to be engaged by the threaded portion of the body. The seal is disposed axially between the first end and the flange.

### CROSS-REFERENCE

The present application claims priority to United States Provisional Patent Application No. 63/745,886, filed January 16, 2025, the entirety of which is incorporated herein by reference.

### TECHNICAL FIELD

The present application relates to pass-through fitting assemblies, particularly to pass-through fitting assemblies for outboard engine assemblies.

### BACKGROUND

A typical outboard engine assembly is generally connected to a watercraft via a transom or mounting bracket, allowing the outboard engine assembly to be connected to a rear portion of the watercraft. Some watercrafts have a rear platform which extends across the transom and is structured to support the weight of one or more occupants. In some instances, the outboard engine assembly is disposed beneath the rear platform such that its engine unit is partially submerged, thereby providing optimal usable space of the rear platform for occupants of the watercraft.

The outboard engine assembly is formed from an engine unit with an internal combustion engine, a propeller providing propulsion to the watercraft, and an exhaust system to bring exhaust from the engine to be expelled out of the engine assembly. At higher, running, speeds the exhaust is typically routed out through the center of the propeller and expelled from a main exhaust outlet into a low-pressure region behind the propeller. However, during idle or lower speeds, a portion of the exhaust system adjacent the main exhaust outlet fills with water, which prevents the exhaust gases from being expelled therethrough. A solution to this problem is to provide the outboard engine assembly with an idle relief system through which the exhaust can be routed even at idle or lower speed.

In some outboard engine assembly, the idle relief system needs to route the exhaust from a main exhaust system disposed inside an engine unit housing of the outboard engine assembly through a wall of the engine unit housing. The main exhaust system has an aperture, and the wall of the engine unit housing also has an aperture through which the idle relief system routes the exhaust. Although the two apertures are designed to be aligned, due to tolerance stacking and manufacturing constraints, it is difficult to have these apertures be perfectly aligned. As such, one or more rubber hoses, or another type of flexible hose, is used to fluidly connect the two apertures to each other. Since the rubber hose(s) is flexible, it can accommodate some misalignment between these two apertures. However, the use of such hoses requires the use of various fittings and clamps to properly install them. This increases the cost and complexity of the idle relief system.

Therefore, there is a desire for an idle relief system for an outboard engine assembly which can accommodate misalignment of apertures, while remaining relatively simple to assemble.

### SUMMARY

It is an object of the present technology to ameliorate at least some of the inconveniences present in the prior art.

According to one aspect of the present technology, there is provided an outboard engine assembly for a watercraft. The outboard engine assembly has an engine unit. The engine unit includes: an engine unit housing defining an engine unit housing wall; and an internal combustion engine disposed in the engine unit housing. The outboard engine assembly also has a gearcase connected to the engine unit housing; an exhaust system; and a propulsion device operatively connected to the engine. The exhaust system includes: an exhaust housing disposed in the engine unit housing, the exhaust housing defining an exhaust passage fluidly communicating with the internal combustion engine, the exhaust passage having an exhaust outlet, the exhaust passage being configured for supplying exhaust gases from the internal combustion engine to an exterior of the outboard engine assembly via the exhaust outlet, the exhaust housing having an exhaust housing wall, the exhaust housing wall defining a first aperture, the exhaust housing wall having a first threaded portion, the engine unit housing wall defining a second aperture, the engine unit housing wall defining an abutment surface around the second aperture; the exhaust housing wall and the engine unit housing wall defining an intermediate zone therebetween; and a pass-through fitting extending between the exhaust housing wall and the engine unit housing wall. The pass-through fitting has: a body having a first end and a second end, the body defining a body passage extending axially from the first end to the second end, the body passage fluidly communicating the exhaust passage with the exterior of the outboard engine assembly via the first aperture and the second aperture, the body passage being fluidly isolated from the intermediate zone; and a flange extending radially outwardly from the body, the flange being disposed axially between the first end and the second end, the body having a second threaded portion disposed axially between the first end and the flange, the second threaded portion engaging the first threaded portion. The exhaust system also has a first seal abutting and disposed radially between the body and the exhaust housing wall for preventing fluid communication between the exhaust passage and the intermediate zone via the first aperture, the first seal being disposed axially between the first end and the flange; and a second seal abutting and disposed axially between the flange and the abutment surface for preventing fluid communication between the exterior of the outboard engine assembly and the intermediate zone via the second aperture.

In some embodiments, the first threaded portion is an internal threaded portion; the second threaded portion is an external threaded portion; and the first seal is disposed around an outside of the body.

In some embodiments, the first seal is an O-ring.

In some embodiments, the body defines an external groove extending around the body; and the first seal is disposed in the groove.

In some embodiments, the second seal is an O-ring.

In some embodiments, the abutment surface defines a groove extending around the second aperture; and the second seal is disposed in the groove.

In some embodiments, the first seal is disposed axially between the second threaded portion and the flange.

In some embodiments, the engine unit housing wall is disposed axially between the flange and the exhaust housing wall.

In some embodiments, the pass-through fitting also has an engagement portion disposed axially between the exhaust housing wall and the second end of the body.

In some embodiments, the engagement portion is a hose barb.

In some embodiments, a hose is connected to the second end of the body via the engagement portion.

In some embodiments, an idle relief muffler is connected to the hose.

In some embodiments, the pass-through fitting also has a tool engaging portion disposed axially between the flange and the second end of the body.

In some embodiments, the tool engaging portion is disposed externally of the body.

In some embodiments, the tool engaging portion is connected to the flange.

In some embodiments, the tool engaging portion is a hexagonal tool engaging portion.

In some embodiments, the first aperture is smaller than the second aperture.

In some embodiments, the body extends through the second aperture such that the second end of the body is outside the engine unit housing; and the second aperture is sized such that a radial gap is provided between the engine unit housing wall and at least a portion of a contour of the body.

In some embodiments, an idle relief muffler is fluidly connected to the second of the body, the idle relief muffler being disposed outside the engine unit housing.

In some embodiments, the idle relief muffler is disposed in a front portion of the outboard engine assembly.

In some embodiments, the idle relief muffler is fluidly connected to an idle relief outlet, the idle relief outlet being positioned on the outboard engine assembly such that, when the outboard engine assembly is operating at idle speed, the idle relief outlet is disposed below a waterline of a boat to which the outboard engine assembly is mounted.

According to another aspect of the present technology, there is provided a fluid delivery assembly having: a first wall defining a first aperture, the wall having a first threaded portion; and a second wall defining a second aperture, the second wall defining an abutment surface around the second aperture. The first and the second walls defining: an intermediate zone between a first side of the first wall and a first side of the second walls, a first zone on a second side of the first wall opposite the first side of the first wall, and a second zone on a second side of the second wall opposite the first side of the first wall. The fluid delivery assembly also has a pass-through fitting extending between the first wall and the second wall. The pass-through fitting has: a body having a first end and a second end, the body defining a body passage extending axially from the first end to the second end, the body passage fluidly communicating the first zone with the second zone via the first aperture and the second aperture, the body passage being fluidly isolated from the intermediate zone; and a flange extending radially outwardly from the body, the flange being disposed axially between the first end and the second end, the body having a second threaded portion disposed axially between the first end and the flange, the second threaded portion engaging the first threaded portion. The fluid delivery assembly also has a first seal abutting and disposed radially between the body and the first wall for preventing fluid communication between the first zone and the intermediate zone via the first aperture, the first seal being disposed axially between the first end and the flange; and a second seal abutting and disposed axially between the flange and the abutment surface for preventing fluid communication between the second zone and the intermediate zone via the second aperture.

In some embodiments, the first threaded portion is an internal threaded portion; the second threaded portion is an external threaded portion; and the first seal is disposed around an outside of the body.

In some embodiments, the first seal is an O-ring.

In some embodiments, the body defines an external groove extending around the body; and the first seal is disposed in the groove.

In some embodiments, the second seal is an O-ring.

In some embodiments, the abutment surface defines a groove extending around the second aperture; and the second seal is disposed in the groove.

In some embodiments, the first seal is disposed axially between the second threaded portion and the flange.

In some embodiments, the second wall is disposed axially between the flange and the first wall.

In some embodiments, the pass-through fitting also has an engagement portion disposed axially between the second wall and the second end in the second zone.

In some embodiments, the engagement portion is a hose barb.

In some embodiments, the pass-through fitting also has a tool engaging portion disposed axially between the flange and the second end.

In some embodiments, the tool engaging portion is disposed externally of the body.

In some embodiments, the tool engaging portion is connected to the flange.

In some embodiments, the tool engaging portion is a hexagonal tool engaging portion.

In some embodiments, the first aperture is smaller than the second aperture.

In some embodiments, the body extends through the second aperture such that the second end of the body is in the second zone; and the second aperture is sized such that a radial gap is provided between the second wall and at least a portion of a contour of the body.

According to another aspect of the present technology, there is provided a pass-through fitting assembly having a pass-through fitting and a seal. The pass-through fitting having: a body having a first end and a second end, the body defining a body passage extending axially from the first end to the second end; and a flange extending radially outwardly from the body, the flange being disposed axially between the first end and the second end, the body having a threaded portion disposed axially between the first end and the flange. The seal abuts the body for sealing in a radial direction between the body and a threaded component to be engaged by the threaded portion of the body. The seal is disposed axially between the first end and the flange.

In some embodiments, the threaded portion is an external threaded portion; and the seal is disposed around an outside of the body.

In some embodiments, the seal is an O-ring.

In some embodiments, the body defines an external groove extending around the body; and the seal is disposed in the groove.

In some embodiments, the seal is disposed axially between the threaded portion and the flange.

In some embodiments, the pass-through fitting also has an engagement portion disposed axially between the flange and the second end.

In some embodiments, the engagement portion is a hose barb.

In some embodiments, the pass-through fitting also has a tool engaging portion disposed axially between the flange and the second end.

In some embodiments, the tool engaging portion is disposed externally of the body.

In some embodiments, the tool engaging portion is connected to the flange.

In some embodiments, the tool engaging portion is a hexagonal tool engaging portion.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

It must be noted that, as used in this specification and the appended claims, the singular form “a,” “an” and “the” include plural referents unless the context clearly dictates otherwise.

For purposes of this application, terms related to spatial orientation such as forward, rearward, upward, downward, left, and right, should be understood in a frame of reference of the outboard engine assembly, as it would be mounted to a watercraft with an outboard engine in a neutral trim position. Terms related to spatial orientation when describing or referring to components or sub-assemblies of the engine assembly separately therefrom should be understood as they would be understood when these components or sub-assemblies are mounted in the outboard engine assembly, unless specified otherwise in this application. The terms “upstream” and “downstream” should be understood with respect to the normal flow direction of fluid inside a component. As such, in an engine assembly, the air intake system is upstream of the engine and the exhaust system is downstream of the engine. Similarly, for a component having an inlet and an outlet, the inlet is upstream of the outlet, and the outlet is downstream of the inlet.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a watercraft provided with an outboard engine assembly;

FIG. 2 is a right side elevation view of the outboard engine assembly of FIG. 1;

FIG. 3 is a perspective view taken from a front, right side of a front portion of the outboard engine assembly of FIG. 2;

FIG. 4 is a perspective view taken from a front, right side of an exhaust housing of the outboard engine assembly of FIG. 2;

FIG. 5 is a cross-sectional view of the outboard engine assembly of FIG. 2, taken through line 5-5 of FIG. 2;

FIG. 6 is a perspective view taken from an inlet end of a pass-through fitting assembly of the outboard engine assembly of FIG. 2;

FIG. 7 is a perspective view taken from an outlet end of the pass-through fitting assembly of FIG. 6; and

FIG. 8 is a top plan view of the pass-through fitting assembly of FIG. 6 shown in a fluid delivery assembly, with walls of the fluid delivery assembly shown in cross-section.

### DETAILED DESCRIPTION

The present disclosure is not limited in its application to the details of construction and the arrangement of components set forth in the following description or illustrated in the drawings. The disclosure is capable of other embodiments and of being practiced or of being carried out in many ways. Also, the phraseology and terminology used herein is for the purpose of description and should not be regarded as limiting. The use of "including", "comprising", or "having", "containing", "involving" and variations thereof herein, is meant to encompass the items listed thereafter as well as, optionally, additional items. In the following description, the same numerical references refer to similar elements.

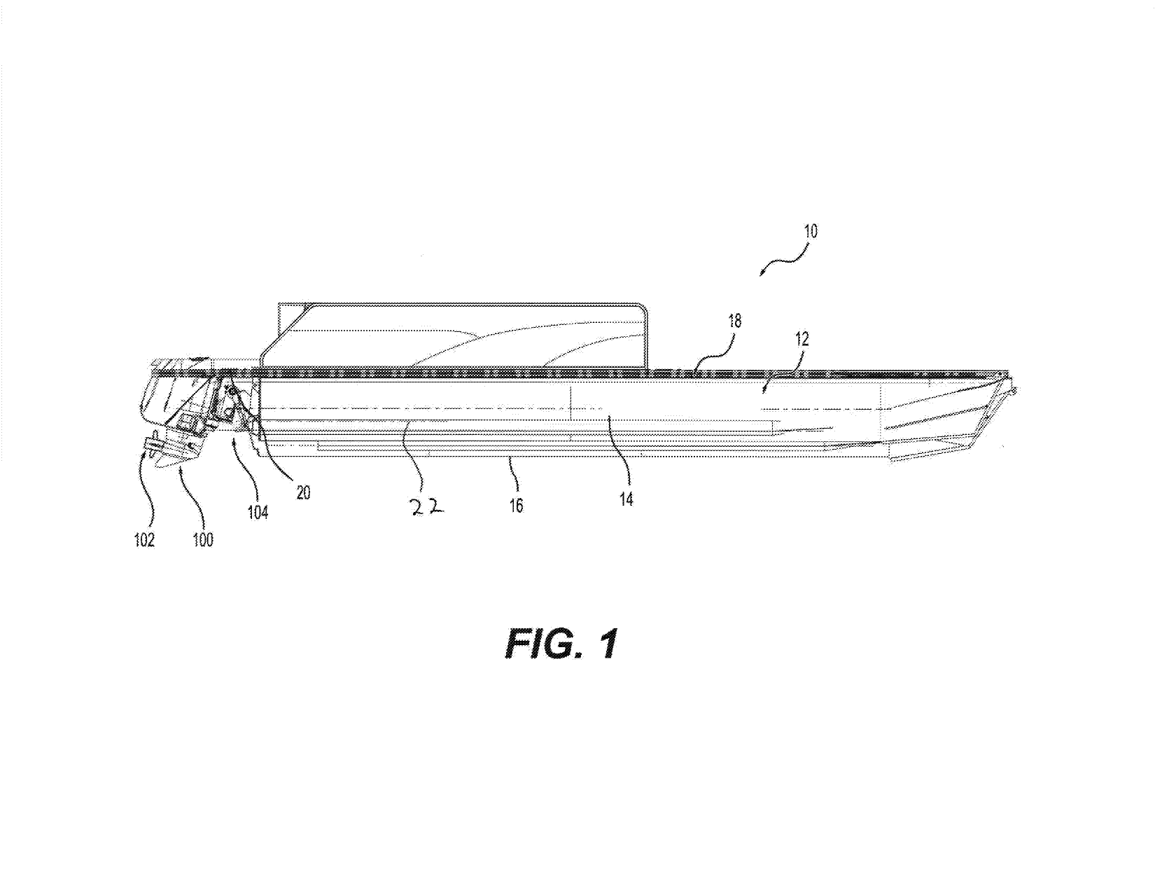

In FIG. 1, a watercraft 10 is illustrated. The watercraft 10 is specifically a pontoon boat 10, but this is simply one non-limiting example of a watercraft according to the present technology. This particular embodiment of the boat 10 includes a watercraft body 12 formed generally from two pontoons 14 (only one being illustrated) and a platform 16.

The boat 10 also includes an outboard engine assembly 100, also referred to herein as the assembly 100. The assembly 100 is pivotably and rotatably connected to the watercraft body 12 for providing propulsion via a propulsion device 102. The propulsion device 102 is specifically a propeller 102 driven by a propeller shaft (not shown) which rotates the propeller 102 about a propeller shaft axis (not shown). It is contemplated that the propulsion device 102 could be different in some embodiments.

The assembly 100 includes a transom bracket 104 which fastens the assembly 100 to the watercraft body 12. In a particular embodiment, the transom bracket 104 is connected to a lower portion of the platform 16 such that the assembly 100 is disposed below a deck 18 of the watercraft body 12 and, more specifically, below a rear platform 20 of the watercraft body 12, laterally between the pontoons 14. The rear platform 20 extends laterally across the width of the boat 10 and is structured to support the weight of one or more occupants. In some embodiments, the rear platform 20 is vertically offset from the deck 18 such that a top surface of the rear platform 20 is vertically above a top surface of the deck 18. It is contemplated, that in an alternative embodiment, the top surface of the rear platform 20 and the top surface of the deck 18 may be at the same level or the top surface of the deck 18 may be vertically above the top surface of the rear platform 20.

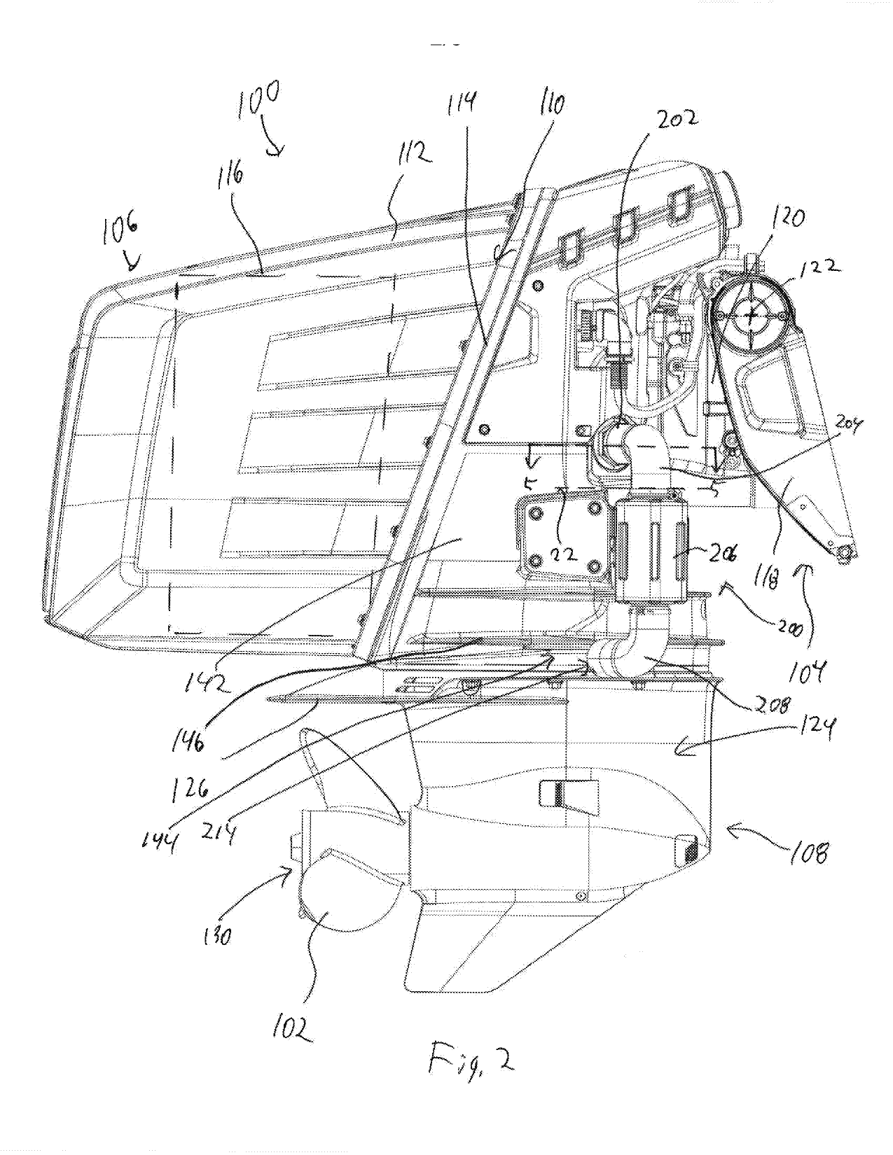

With reference now to FIG. 2, the outboard engine assembly 100, shown separately from the boat 10, will now be described in further detail. The assembly 100 includes an engine unit 106, a lower unit 108, and the transom bracket 104.

The engine unit 106 includes an engine unit housing 110 for supporting and covering components disposed therein. The housing 110 is sealed such that water in which the engine unit housing 110 is immersed is impeded from entering the engine unit housing 110 during normal operating conditions including when at rest and components of the engine unit 106 inside the housing 110 are water-proofed to the same degree as in a conventional outboard engine. Depending on the specific embodiment of the housing 110 and methods used to produce a generally water-tight seal, the housing 110 could be waterproof to varying degrees. It is contemplated that the housing 110 could receive different treatments to seal the housing 110 depending on the specific application for which the marine engine assembly 100 is going to be used. In the present embodiment, the housing 110 includes a cowling 112. The cowling is fastened to the rest of the housing 110 along a diagonally extending parting line 114. A seal (not shown) is provided between the cowling 112 and the rest of the housing 110 along the parting line 114.

The engine unit 106 includes an internal combustion engine 116 (schematically shown in FIG. 2) disposed in the engine unit housing 110 for powering the assembly 100 and driving the propeller 102. By removing the cowling 112, the engine 116 can be accessed. In certain embodiments, the internal combustion engine 116 is a three-cylinder, two-stroke, gasoline-powered, direct injected internal combustion engine. It is contemplated that the internal combustion engine 116 could be another type of internal combustion engine, such as a four-stroke internal combustion engine. It is contemplated that the engine 116 could have more or less than three cylinders. In alternative embodiments, the internal combustion engine 116 could use a fuel other than gasoline, such as diesel.

The transom bracket 104 includes a watercraft portion 118 which is adapted for fastening to the watercraft body 12. The bracket 104 also includes an engine portion 120, pivotally connected to the watercraft portion 118, and which is fastened to the engine unit housing 110. The engine portion 120 is pivotable with respect to the watercraft portion 118 about a tilt-trim axis 122, about which the assembly 100 can be trimmed or tilted relative to the watercraft body 12.

As the assembly 100 is designed to be disposed below the deck 18, more specifically the rear platform 20, the engine 116 and the transom bracket 104 partially vertically overlap, rather than the engine 116 being disposed well above the bracket 104 as would be the case in a conventional outboard engine assembly meant to extend higher relative to the deck 18.

The lower unit 108 includes a gearcase 124 fastened to the engine unit housing 110. The lower unit 108 includes an anti-ventilation plate 126 extending from the gearcase 124. The anti-ventilation plate 126 extends rearward above the propeller 102, creating a barrier of higher water pressure, to prevent surface air or exhaust gases from being drawn into the propeller 102.

The lower unit 108 further includes a driveshaft, a transmission, the propeller shaft (all not shown), and the propeller 102. The engine 116 drives an output shaft (now shown) which drives the driveshaft, which drives the transmission which, in turn, selectively drives the propeller shaft connected to the propeller 102.

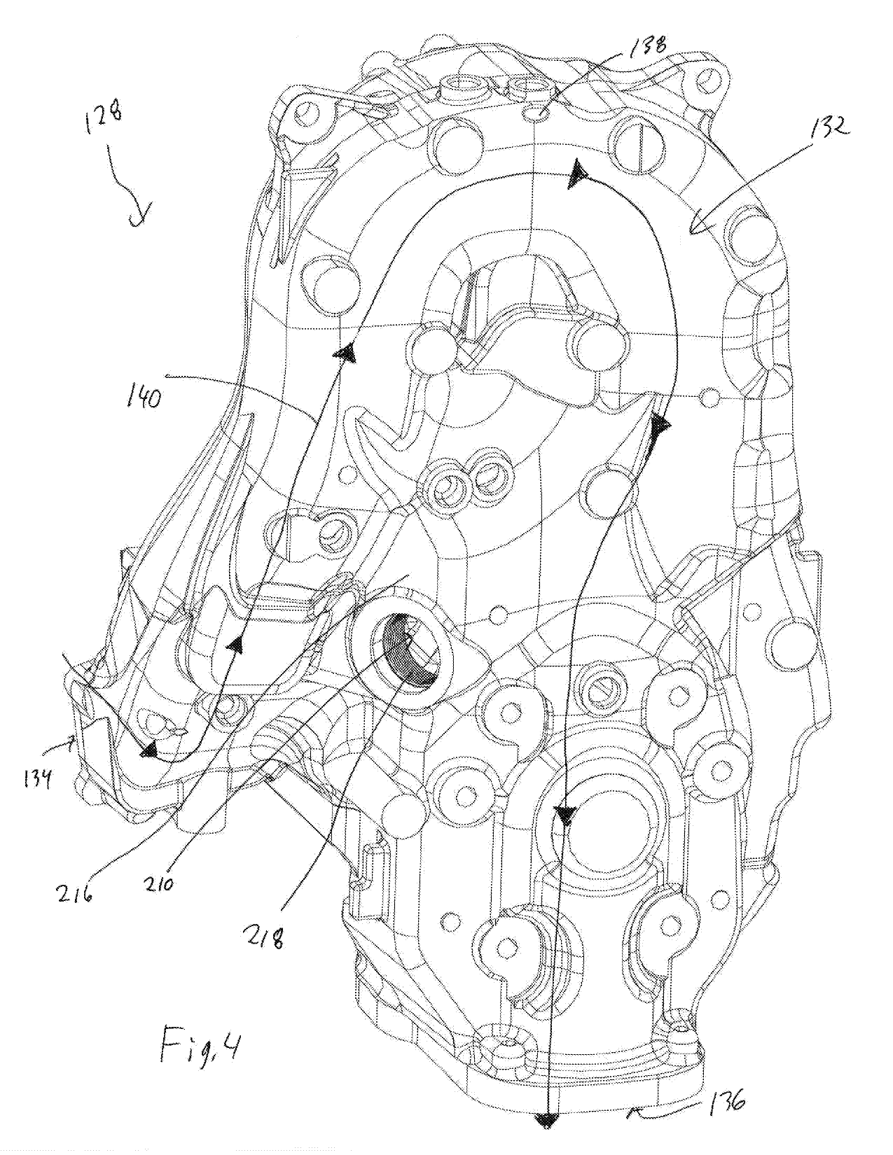

An exhaust system of the assembly 100 includes an exhaust manifold (not shown), and an exhaust housing 128 (FIG. 4) both disposed in the engine unit housing 110, and a main exhaust outlet 130. Exhaust gases from each cylinder of the engine 116 flow into the exhaust manifold. From the manifold, exhaust gases flow into an exhaust passage 132 defined by the exhaust housing 128 via an exhaust inlet 134 (FIG. 4) of the exhaust passage 132. Exhaust gas flows out of the exhaust passage 132 via an exhaust outlet 136 (FIG. 4) into the gearcase 124. The exhaust gas flows downward and under the output shaft to be expelled from the main exhaust outlet 130 through the center of the propeller 102 under water, into the low-pressure region immediately behind the propeller 102 when the assembly 100 is under running speeds.

The exhaust housing 128 is located in front of the engine 116. With reference to FIG. 4, from the exhaust inlet 134, the exhaust passage 132 extends forwards and upward, then curves and extends downward and rearward, thus forming a gooseneck having an apex 138. The exhaust passage 132 is thus referred to as a high rise exhaust passage. Exhaust gas flows in the exhaust passage 132 in the direction indicated by arrow 140.

During idle or low speeds, exhaust gas pressure is too low to keep water out of the lower portion of the exhaust system. As a result, water can flow into the passages and channels through the main exhaust outlet 130 and rise to or close to the same level as the water outside of the outboard engine assembly 100 (i.e., the waterline 22, FIG. 1). The exhaust system also includes an idle relief system 200 to allow exhaust gases to flow out of the outboard engine assembly 100 when the passage of exhaust gas via the exhaust outlet 130 is blocked by water.

With reference to FIG. 2, the idle relief system 200 includes a pass-through fitting 202, a 90-degree hose 204, an idle relief muffler 206, and another 90 degree-hose 208.

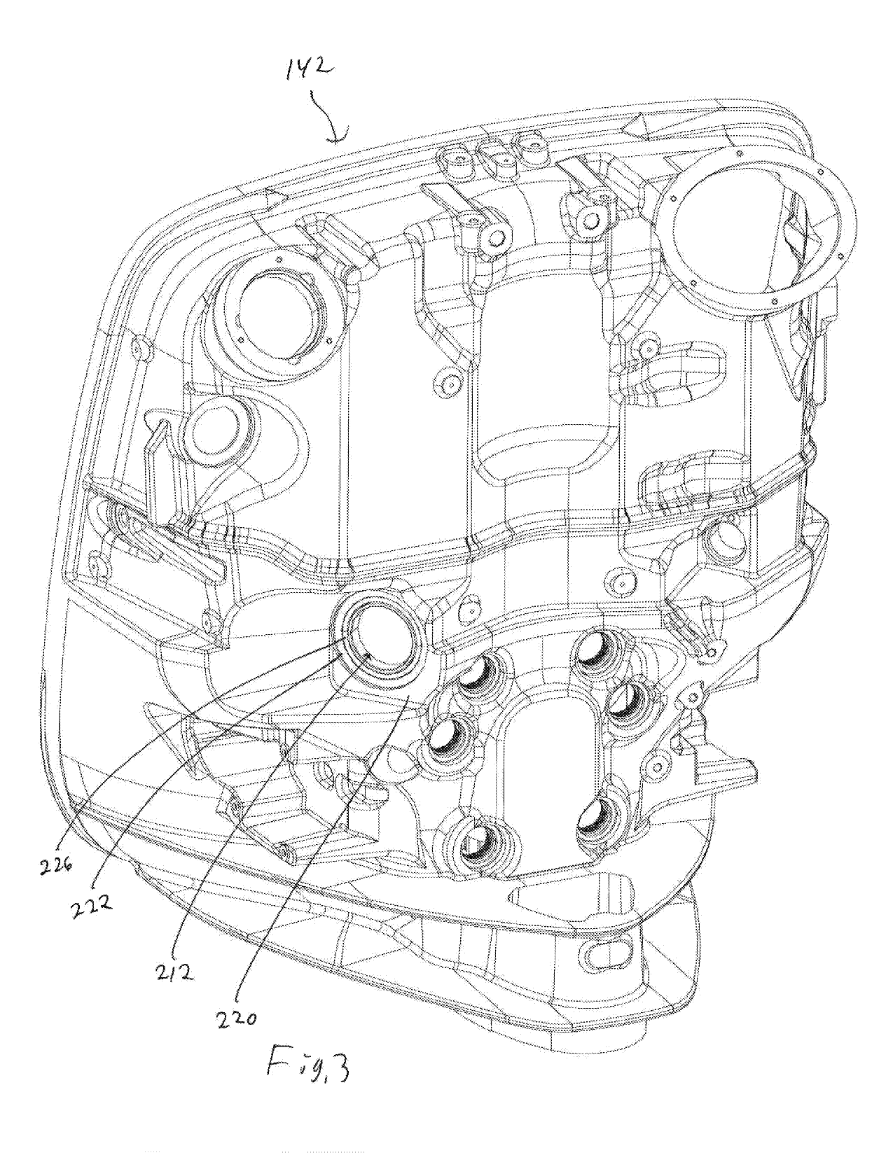

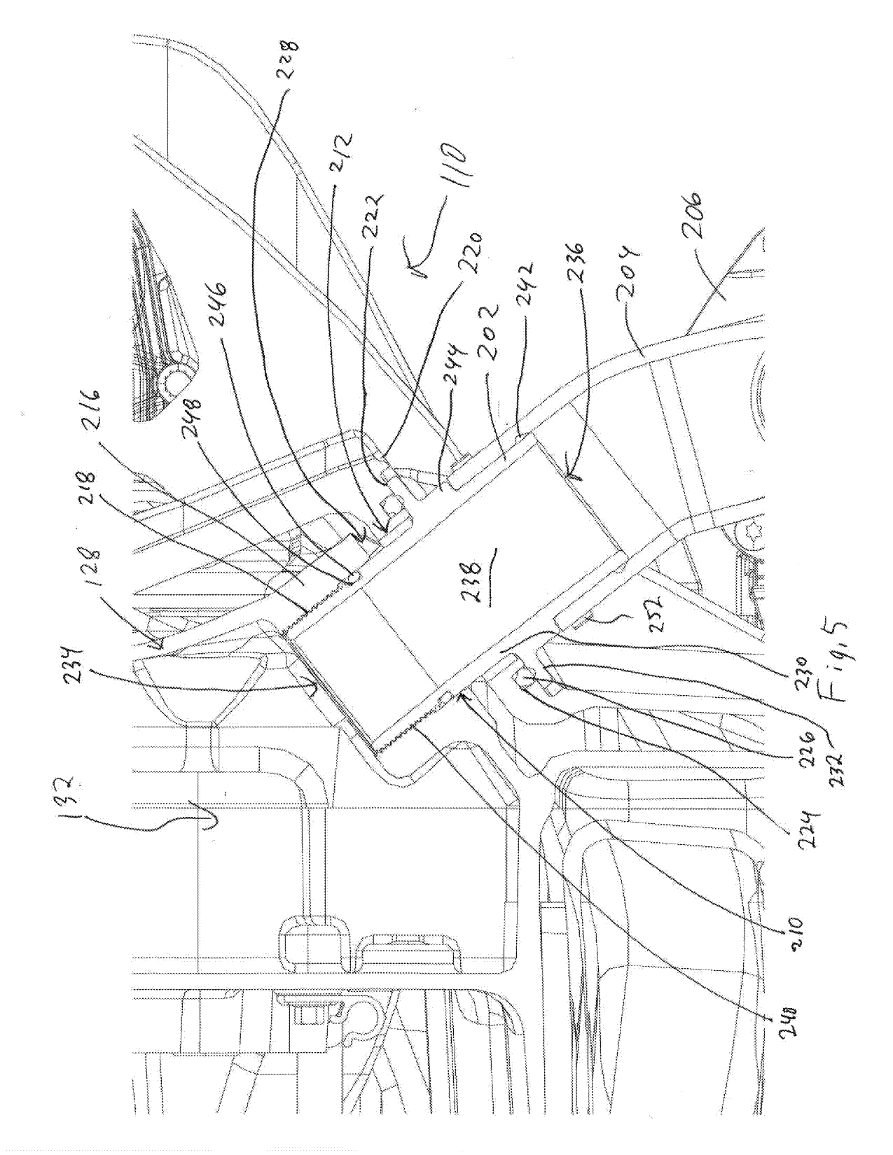

The exhaust housing 128 defines an aperture 210 (FIG. 4) on a front, right side thereof that is fluidly connected with the exhaust passage 132. A front portion 142 of the engine unit housing 110 defines an aperture 212 (FIG. 3) on a front, right side thereof that is generally aligned with the aperture 210. It is contemplated that both apertures 210, 212 could both be disposed on a front or a front, left side of the exhaust housing 128 and the front portion 142 of the engine unit housing 110, or at other suitable positions thereon, as long as they are generally aligned with each other. As can be seen in FIG. 5, the pass-through fitting 202 is connected to the exhaust housing 128 and fluidly communicates the exhaust passage 132 with an exterior of the engine unit housing 110 via the apertures 210, 212. During idle or low speed operation of the assembly 100, the apertures 210, 212 and the pass-through fitting 202 are above the waterline 22, as can be seen in FIG. 2. In the present embodiment, the aperture 210 connects to the exhaust passage 132 at a location downstream from the apex 138, preventing water from bypassing the gooseneck of the exhaust passage 132 and entering the engine 116 which would impact its proper functioning. The apertures 210, 212 and the pass-through fitting 202 will be described in more detail further below.

The 90-degree hose 204 connects to the pass-through fitting 202 outside of the engine unit housing 110. An outlet of the 90-degree hose 204 points generally downward. The idle relief muffler 206 is connected to the outlet of the 90-degree hose 204, and as such is disposed in a front, right portion of the assembly 100. The 90-degree hose 208 is connected to an outlet of the idle relief muffler 206. The 90-degree hose 208 defines an idle relief outlet 214. During idle or low speed operation of the assembly 100, the idle relief outlet 214 is disposed below the waterline 22 (FIG. 2. During operation, exhaust gases flow from the exhaust passage 132, to the pass-through fitting 202, then to the hose 204, the idle relief muffler, the hose 208, and out of the idle relief system 200 via the idle relief outlet 214.

It is contemplated that in some embodiments, the idle relief muffler 206 could be omitted, and replaced by a straight hose or by one or both of the 90-degree hoses 204, 208 having longer vertical components. It is contemplated that in some embodiments, the 90-degree hose 208 could be omitted or replaced by a straight hose. It is also contemplated that in some embodiments, the hoses 204, 208 and the idle relief muffler 206 could be omitted, such that exhaust gases would be expelled directly in the atmosphere above the waterline 22 from the pass-through fitting 202.

The idle relief outlet 214 is disposed vertically lower than the waterline 22 (FIG. 2), that is the level reached by the water on the outside of the watercraft 10 when the outboard engine assembly 100 is at rest or running at low speeds. As described above, exhaust gases are expelled from the idle relief outlet 214 just below the waterline 22. At this depth, the water pressure is not high enough to block exhaust gases from exiting the idle relief outlet 214. When the exhaust gas is released, it moves upwards towards the water surface which results in the gas being cooled, becoming heavier, and preventing some or all components of the gas from rising above the outboard engine assembly 100 and above the rear platform 20. However, the idle relief outlet 194 should not be positioned too far below the water surface as to impact the proper function of the outboard engine assembly 100. The idle relief outlet 214 is disposed below the transom bracket 104 and above the gearcase 124 and the anti-ventilation plate 126. The idle relief outlet 214 faces leftward and rearward and faces the front, lower, right portion of the engine unit housing 110. More specifically, the idle relief outlet 214 faces a volume 144 defined beneath an anti-splash flange 146 along the front, lower, right portion of the engine unit housing 110 so as to expel exhaust gases in this volume144. By directing exhaust gases in the volume 144, the exhaust gases are trapped longer under water, giving them more time to cool. In the present embodiment, the idle relief outlet 194 expels exhaust gases between 6 to 8 inches below the waterline 22. As the watercraft 10 increases speed and is lifted to be on plane, the idle relief outlet 214 is above the waterline 22. However, when this occurs, exhaust gases can now be expelled via the main exhaust outlet 130.

Turning now to FIGS. 3 to 5, the apertures 210 and 212 and the regions surrounding these apertures 210, 212 will be described in more detail. As can be seen in FIG. 5, the aperture 210 is smaller than the aperture 212. With reference to FIG. 4, the exhaust housing 128 has an exhaust housing wall 216 in which the aperture 210 is defined. The exhaust housing wall 216 also has an internal threaded portion 218 through which the aperture 210 extends. With reference to FIG. 3 and 5, the front portion 142 of the engine unit housing 110 has an engine unit housing wall 220 in which the aperture 212 is defined. The engine unit housing wall 220 defines an abutment surface 222 around the aperture 212 on an outside of the wall 220. The abutment surface 222 defines a groove 224 extending around the aperture 212. A seal 226, which in this embodiment is an O-ring 226, is disposed in the groove 224. The walls 216 and 220 define an intermediate zone 228 (FIG. 5) therebetween.

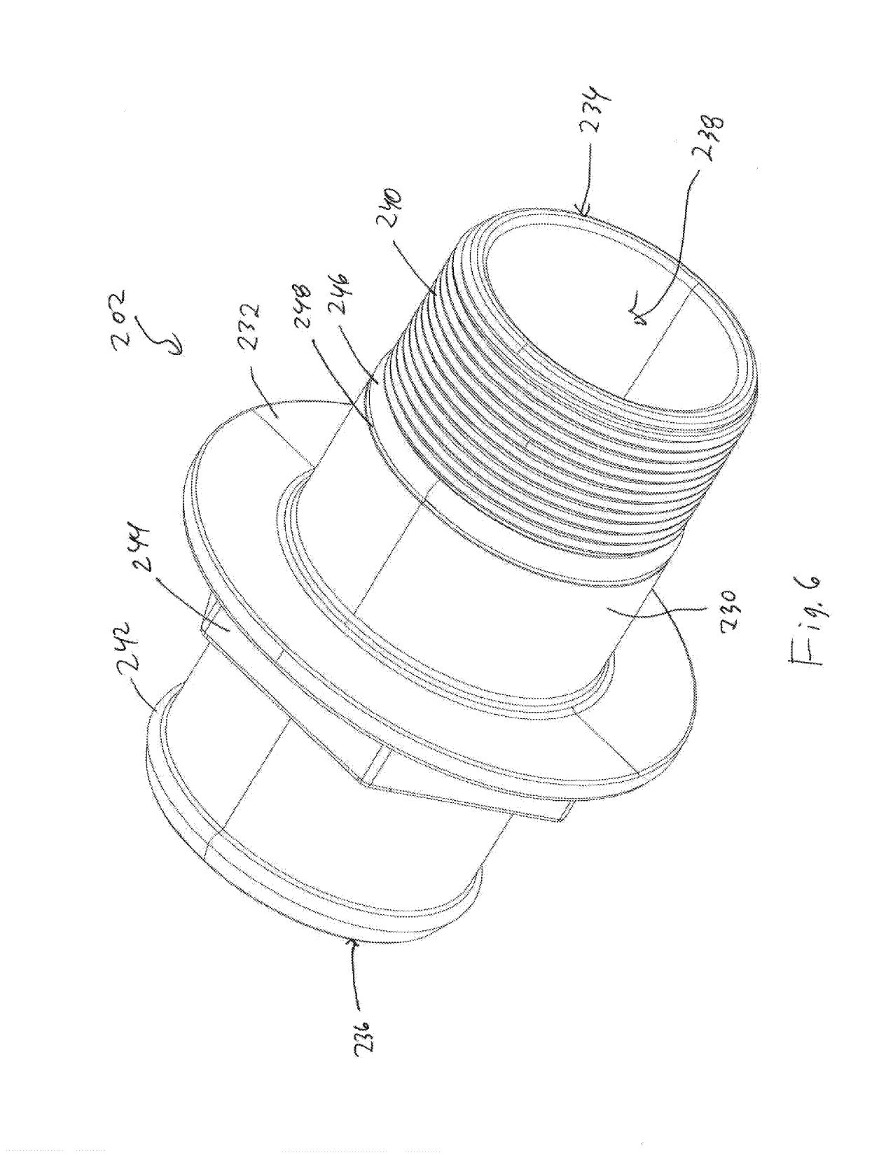

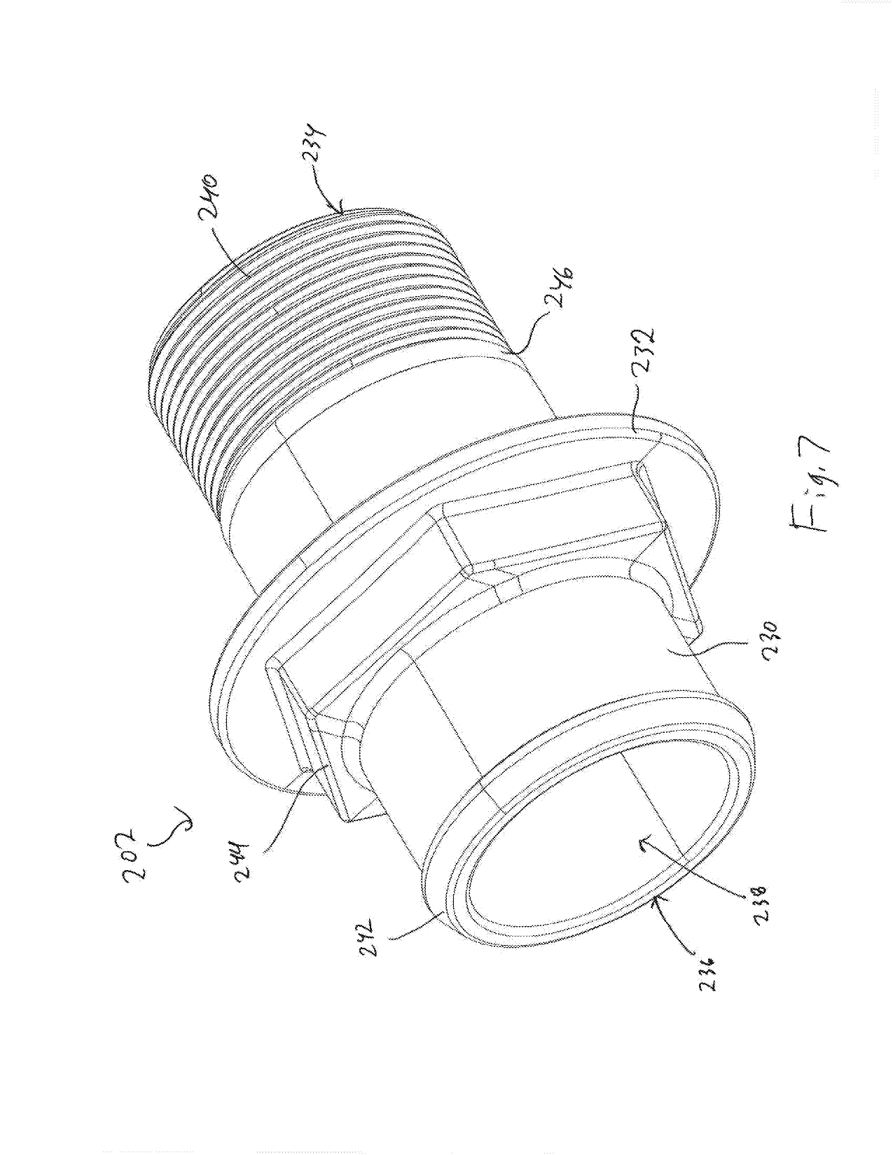

Turning now to FIGS. 6 and 7, the pass-through fitting 202 will be described in more detail. The pass-through fitting 202 has a body 230 and a flange 232. In the present embodiment, the body 230 is tubular. The body 230 has an inlet end 234 and an outlet end 236. The body 230 defines a body passage 238 extending axially from the inlet end 234 to the outlet end 236. The body 230 has a diameter that is smaller than a diameter of the aperture 212 in the engine unit housing wall 220.

The flange 232 is an annular flange 232 extending radially outwardly from the body 230. As can be seen, the flange 232 is disposed axially between the inlet end 234 and the outlet end 236. The flange 232 has a diameter that is larger than the diameter of the aperture 212 in the engine unit housing wall 220. The flange 232 is configured to abut the abutment surface 222.

The body 230 also has an external threaded portion 240 disposed axially between the inlet end 234 and the flange 232. In the present embodiment, the threaded portion 240 is disposed next to the inlet end 234. The threaded portion 240 is configured to engage the threaded portion 218.

The pass-through fitting 202 also has an engagement portion 242 disposed axially between the flange 232 and the outlet end 236. In the present embodiment, the engagement portion 242 is a hose barb 242 disposed next to the outlet end 236. It is contemplated that the engagement portion 242 could be omitted or could be something other than a hose barb.

The pass-through fitting 202 also has a tool engaging portion 244 disposed externally of the body 230, axially between the flange 232 and the outlet end 236. It is contemplated that the tool engaging portion 244 could be disposed internally of the body 230. In the present embodiment, the tool engaging portion 244 is connected to the flange 232, but it is contemplated that the tool engaging portion 244 could be spaced from the flange 232. In the present embodiment, the tool engaging portion 244 is a hexagonal tool engaging portion 244. The tool engaging portion 244 can be engaged by a wrench to facilitate installation of the pass-through fitting 202 as will be described below. It is contemplated that the tool engaging portion 244 could have more or less than six sides or could be of a different type. For example, the tool engaging portion 244 could be an annulus with one or more notches and/or protrusions to be engaged by a custom tool.

In the present embodiment, the body 230, the flange 232, the hose barb 242 and the tool engaging portion 244 are molded from plastic together such that the pass-through fitting 202 has a monolithic construction. It is contemplated that materials other than plastic, such as metal, could be used. It is also contemplated that the pass-through fitting 202 could be made from separate parts that are welded, bonded, or otherwise connected to each other to form the pass-through fitting 202.

A seal 246 abuts and is disposed around an outside of the body 230. The seal 246 and the pass-through fitting 202 together define a pass-through fitting assembly. The seal 246 is disposed between the inlet end 234 and the flange 232. In the present embodiment, the seal 246 is disposed axially between the threaded portion 240 and the flange 232. More specifically, the seal 246 is disposed next to the threaded portion 240. The body 230 also defines an external groove 248 that extends around the body 230. The seal 246 is disposed in the groove 248. When the pass-through fitting 202 is installed, the seal 246 seals in a radial direction between the body 230 and the exhaust housing wall 216 as can be seen in FIG. 5. In the present embodiment, the seal 246 is an O-ring 246, but other types of seals are contemplated.

To mount the pass-through fitting 202 to the rest of the assembly 100, the inlet end 234 is inserted from outside the engine unit housing 110 into the aperture 212 and then into the aperture 210. A tool is then used to engage the tool engaging portion 244 to turn the pass-through fitting 202, causing the threaded portion 240 to engage the threaded portion 218. The pass-through fitting 202 is turned until the flange 232 abuts the abutment surface 222 and the seal 226, thereby squeezing the seal 226 that is disposed axially between the flange 232 and the abutment surface 222. It is contemplated that the pass-through fitting 202 could be turned until the tool applies a predetermined torque to the pass-through fitting 202.

As the aperture 212 has a greater diameter than the body 230 of the pass-through fitting 202, a radial gap 250 is provided between the engine unit housing wall 220 and a contour of the body 230. This radial gap 250 allows for some degree of radial misalignment between the aperture 210 and 212. It is contemplated that the aperture 212 could be even larger to allow for a greater degree of misalignment, provided that the flange 232 is large enough to abut the seal 226 provided around the aperture 212. It would be understood that should the apertures 210 and 212 be sufficiently radially misaligned, the body 230 of the pass-through fitting 202 could abut the edge of the wall 220 defining the aperture 212, and as such the radial gap 250 would only exist around a portion of the contour of the body 230. The use of the threaded portions 218, 240 also allows for some variations in the distance between the walls 216, 220 where the apertures 210, 212 are defined. The pass-through fitting 202 is simply screwed in more or less in the threaded portion 218 depending on this distance.

With reference to FIG. 5, once the pass-through fitting 202 is installed, the body 230 extends through the aperture 212 and in the aperture 210 such that the pass-through fitting 202 extends between the exhaust housing wall 216 and the engine unit housing wall 220. The engine housing unit wall 220 is disposed axially between the flange 232 and the exhaust housing wall 216. The outlet end 236 is disposed outside of the engine unit housing 110. The 90-degree hose 204 is connected to the outlet end 236 of the body 230 via the hose barb 242. A clamp 252 is additionally provided around the hose 204 to secure the hose 204 to the body 230.

The body passage 238 of the pass-through fitting 202 fluidly communicate the exhaust passage 132 with the exterior of the outboard engine assembly 100 via the apertures 210, 212 and the rest of the components of the idle relief system 200. The seal 246 abuts and is disposed radially between the body 230 and the exhaust housing wall 220 for preventing fluid communication between the exhaust passage 132 and the intermediate zone 228 via the aperture 210. The seal 226 abuts and disposed axially between the flange 232 and the abutment surface 222 for preventing fluid communication between the exterior of the outboard engine assembly 100 and the intermediate zone 228 via the aperture 212, thereby preventing water to enter the engine unit housing 110 via the aperture 212. As such, the body passage 238 is fluidly isolated from the intermediate zone 228, thereby preventing exhaust gases flowing in the body passage 238 from flowing into the intermediate zone 228.

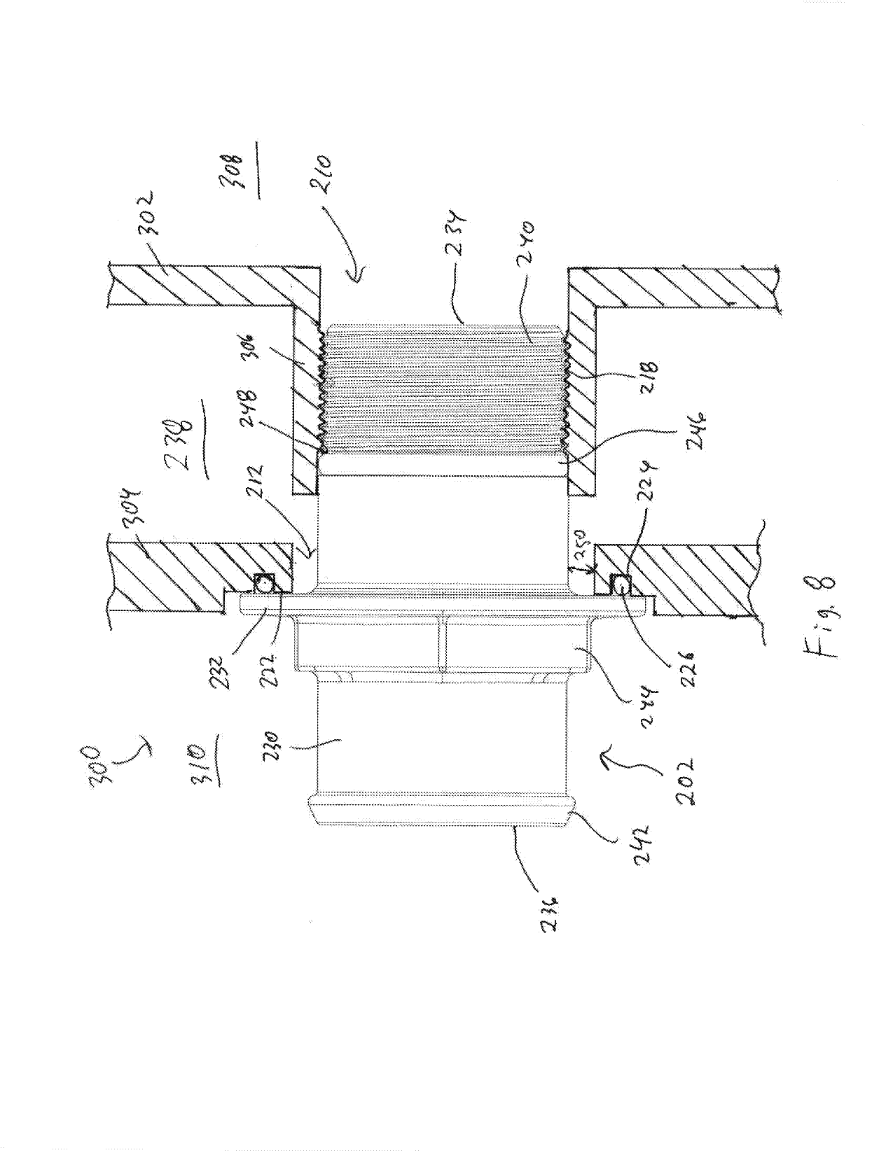

Although the pass-through fitting 202 has been described until now as part of the outboard engine assembly 100, and specifically as part of the idle relief system 200, it is contemplated that the pass-through fitting 202 could be used in other types of fluid delivery assemblies. An embodiment of a fluid delivery assembly 300 including the pass-through fitting 202 will be described with respect to FIG. 8. For simplicity, components of the fluid delivery assembly 300 that are similar to those of the outboard engine assembly 100 have been provided with the same reference numerals and will not be described again in detail.

The assembly 300 has a wall 302 and a wall 304. The wall 302 defines the aperture 210 and has a collar 306 having the threaded portion 218. The seal 246 is radially between the body 230 and the collar 306. The wall 304 defines the aperture 212 and the abutment surface 222. The intermediate zone 228 is defined between the walls 302, 304. A zone 308 is defined on a side of the wall 302 opposite the side on which the intermediate zone 228 is defined. A zone 310 is defined on a side of the wall 304 opposite the side on which the intermediate zone 228 is defined. The body passage 238 fluidly communicates the zones 308, 310 with each other, while being fluidly isolated from the intermediate zone 228. It is contemplated that fluid could flow from the zone 310 to the zone 308 via the body passage 238. In such an embodiment, the end 236 would be called the inlet end and the end 234 would be called the outlet end.

In an alternative embodiment of the assembly 300, the collar 306 extends inside the body passage 238. In such an embodiment, the collar 306 has an external threaded portion instead of the internal threaded portion 218 and the body 230 has an internal threaded portion instead of the external threaded portion 240. Also, the seal 246 is disposed inside the body 230 so as to be radially between the collar 306 and the inner surface of the body 230.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. An outboard engine assembly for a watercraft, comprising:
an engine unit including:
an engine unit housing defining an engine unit housing wall; and
an internal combustion engine disposed in the engine unit housing;
a gearcase connected to the engine unit housing;
an exhaust system including:
an exhaust housing disposed in the engine unit housing, the exhaust housing defining an exhaust passage fluidly communicating with the internal combustion engine,
the exhaust passage having an exhaust outlet, the exhaust passage being configured for supplying exhaust gases from the internal combustion engine to an exterior of the outboard engine assembly via the exhaust outlet,
the exhaust housing having an exhaust housing wall,
the exhaust housing wall defining a first aperture,
the exhaust housing wall having a first threaded portion,
the engine unit housing wall defining a second aperture,
the engine unit housing wall defining an abutment surface around the second aperture;
the exhaust housing wall and the engine unit housing wall defining an intermediate zone therebetween; and
a pass-through fitting extending between the exhaust housing wall and the engine unit housing wall, the pass-through fitting comprising:
a body having a first end and a second end, the body defining a body passage extending axially from the first end to the second end, the body passage fluidly communicating the exhaust passage with the exterior of the outboard engine assembly via the first aperture and the second aperture, the body passage being fluidly isolated from the intermediate zone; and
a flange extending radially outwardly from the body, the flange being disposed axially between the first end and the second end,
the body having a second threaded portion disposed axially between the first end and the flange, the second threaded portion engaging the first threaded portion;
a first seal abutting and disposed radially between the body and the exhaust housing wall for preventing fluid communication between the exhaust passage and the intermediate zone via the first aperture, the first seal being disposed axially between the first end and the flange; and
a second seal abutting and disposed axially between the flange and the abutment surface for preventing fluid communication between the exterior of the outboard engine assembly and the intermediate zone via the second aperture; and
a propulsion device operatively connected to the engine.

2. The outboard engine assembly of claim 1, wherein:
the first threaded portion is an internal threaded portion;
the second threaded portion is an external threaded portion; and
the first seal is disposed around an outside of the body.

3. The outboard engine assembly of claim 2, wherein:
the body defines an external groove extending around the body; and
the first seal is disposed in the groove.

4. The outboard engine assembly of claim 1, wherein the first seal and the second seal are O-rings.

5. The outboard engine assembly of claim 1, wherein:
the abutment surface defines a groove extending around the second aperture; and
the second seal is disposed in the groove.

6. The outboard engine assembly of claim 1, wherein the first seal is disposed axially between the second threaded portion and the flange.

7. The outboard engine assembly of claim 1, wherein the engine unit housing wall is disposed axially between the flange and the exhaust housing wall.

8. The outboard engine assembly of claim 1, wherein the pass-through fitting further comprises an engagement portion disposed axially between the exhaust housing wall and the second end of the body.

9. The outboard engine assembly of claim 8, wherein the engagement portion is a hose barb.

10. The outboard engine assembly of claim 8, further comprising a hose connected to the second end of the body via the engagement portion.

11. The outboard engine assembly of claim 10, further comprising an idle relief muffler connected to the hose.

12. The outboard engine assembly of claim 1, wherein the pass-through fitting further comprises a tool engaging portion disposed axially between the flange and the second end of the body.

13. The outboard engine assembly of claim 12, wherein the tool engaging portion is disposed externally of the body.

14. The outboard engine assembly of claim 13, wherein the tool engaging portion is connected to the flange.

15. The outboard engine assembly of claim 13, wherein the tool engaging portion is a hexagonal tool engaging portion.

16. The outboard engine assembly of claim 1, wherein the first aperture is smaller than the second aperture.

17. The outboard engine assembly of claim 1, wherein:
the body extends through the second aperture such that the second end of the body is outside the engine unit housing; and
the second aperture is sized such that a radial gap is provided between the engine unit housing wall and at least a portion of a contour of the body.

18. The outboard engine assembly of claim 1, further comprising an idle relief muffler fluidly connected to the second of the body, the idle relief muffler being disposed outside the engine unit housing.

19. The outboard engine assembly of claim 18, wherein the idle relief muffler is disposed in a front portion of the outboard engine assembly.

20. The outboard engine assembly of claim 18 wherein the idle relief muffler is fluidly connected to an idle relief outlet, the idle relief outlet being positioned on the outboard engine assembly such that, when the outboard engine assembly is operating at idle speed, the idle relief outlet is disposed below a waterline of a boat to which the outboard engine assembly is mounted.
